(19) United States
(12) Patent Application Publication
(10) Pub. No.: US 2017/0181563 A1
(43) Pub. Date: Jun. 29, 2017

(54) GARLIC PROCESSOR

(71) Applicants: Jared Waldner, North Vancouver (CA); Stephanie Hewitt, North Vancouver (CA)

(72) Inventors: Jared Waldner, North Vancouver (CA); Stephanie Hewitt, North Vancouver (CA)

(21) Appl. No.: 14/979,987

(22) Filed: Dec. 28, 2015

(51) Int. Cl. A47J 17/18; A47J 17/20

(52) U.S. Cl. CPC A47J 17/18; A47J 17/20

(57) ABSTRACT

A garlic processor can include a container and at least one of a bristle and a blade edge. The container can extend along a central longitudinal axis between first and second ends. The container can include first and second members selectively engageable with one another. At least one of the first and second members can be configured to receive one or more cloves of garlic when the first and second members are disengaged with one another. The first and second members can cooperate to define a chamber when the first and second members are engaged with one another. The at least one of the bristle and the blade edge can project away from a side wall of the container into the chamber toward the axis and be directed toward one of the first and second ends.

### BACKGROUND

1. Field

The present disclosure relates to an apparatus for preparing and treating substances (foods) intended to be eaten and more particularly to a device for processing garlic.

2. Description of Related Prior Art

U.S. Pat. No. 6,752,340 discloses a GARLIC PROCESSOR. The garlic processor of the '340 patent is for processing a garlic clove having a husk and includes a motor having a spindle, a cutting disk, disposed on the spindle and having cutting surfaces, and a cover, having a bottom opening, configured to removably mount with the bottom opening surrounding the cutting disk. The motor gives the cutting disk a rotational speed sufficient to both (i) remove the husk of a garlic clove which comes in contact therewith, and (ii) mash the garlic clove and fling particles thereof outwardly onto the inside surface of the cover.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A garlic processor can include a container and at least one of a bristle and a blade edge. The container can extend along a central longitudinal axis between a first end and a second end opposite the first end. The container can have a side wall. The container can include a first member and a second member. The first member can define a first inner surface and a first outer surface. The second member can define a second inner surface and a second outer surface. The first member and the second member can be selectively engageable with one another. At least one of the first member and the second member can be configured to receive one or more cloves of garlic when the first member and the second member are disengaged with one another. The first inner surface and the second inner surface can cooperate to define a chamber when the first member and the second member are engaged with one another. The at least one of the bristle and the blade edge can project away from the side wall in the chamber toward the axis and be directed toward one of the first end and the second end.

### BRIEF DESCRIPTION OF THE DRAWINGS

The detailed description set forth below references the following drawings:

FIG. 1 is an exploded view of a garlic processor according to an exemplary embodiment of the present disclosure;

FIG. 2 is a cross-sectional view of the garlic processor shown in FIG. 1 taken along section lines 2-2;

FIG. 3 is a detail view of the garlic processor shown in FIGS. 1 and 2 taken along detail line 2 in FIG. 2;

FIG. 4 is a detail view of the garlic processor shown in FIG. 1 and is analogous to FIG. 3;

FIG. 5 is an exploded view of a garlic processor according to another exemplary embodiment of the present disclosure;

FIG. 6 is a first view taken in a plane perpendicular to a central longitudinal axis of a garlic processor according to one or more embodiments of the present disclosure;

FIG. 7 is a second view taken in a plane perpendicular to a central longitudinal axis of a garlic processor according to one or more embodiments of the present disclosure;

FIG. 8 is a third view taken in a plane perpendicular to a central longitudinal axis of a garlic processor according to one or more embodiments of the present disclosure;

FIG. 9 is a side view of an exemplary shaking machine for shaking one or more embodiments of the present disclosure; and

FIG. 10 is a third view taken in a plane perpendicular to a central longitudinal axis of a garlic processor according to one or more embodiments of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide device to process garlic. A garlic processor according to an embodiment of the present disclosure can be utilized to peel and chop a clove of garlic. A garlic clove can be placed in a garlic processor with a bristle arrangement and the garlic processor can be shaken to remove the skin of the garlic. A garlic clove with the skin removed can be placed in a garlic processor with a blade edge arrangement and the garlic processor can be shaken to dice the garlic. The garlic processor can be shaken by hand or with an electric shaking machine. The garlic processor can be practice using a single container with interchangeable bristle and blade edge structures or with multiple containers each having one of a bristle structure and a blade edge structure.

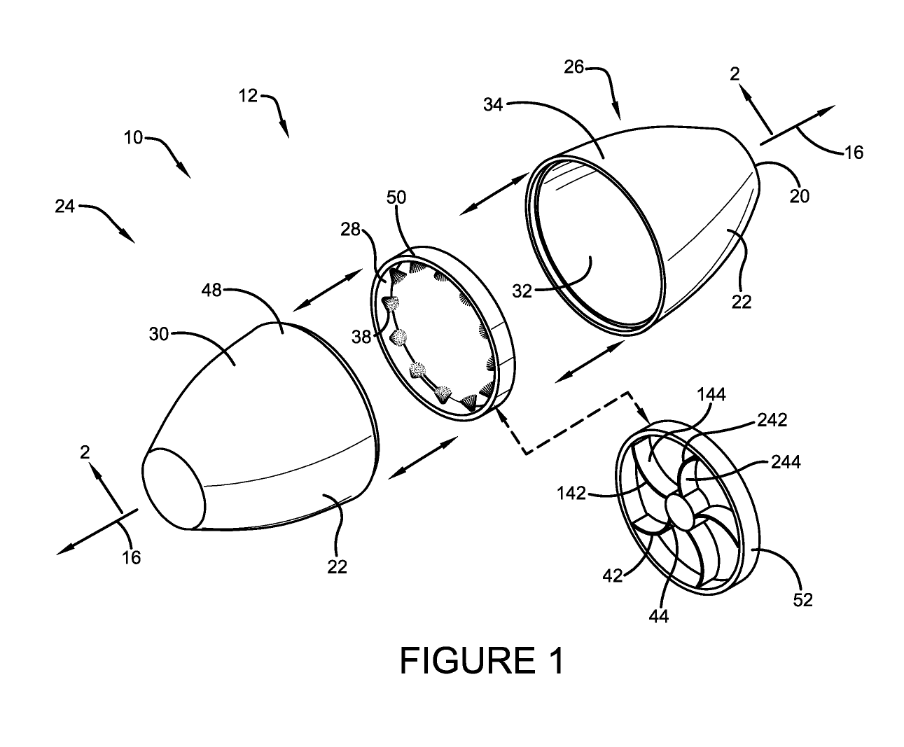

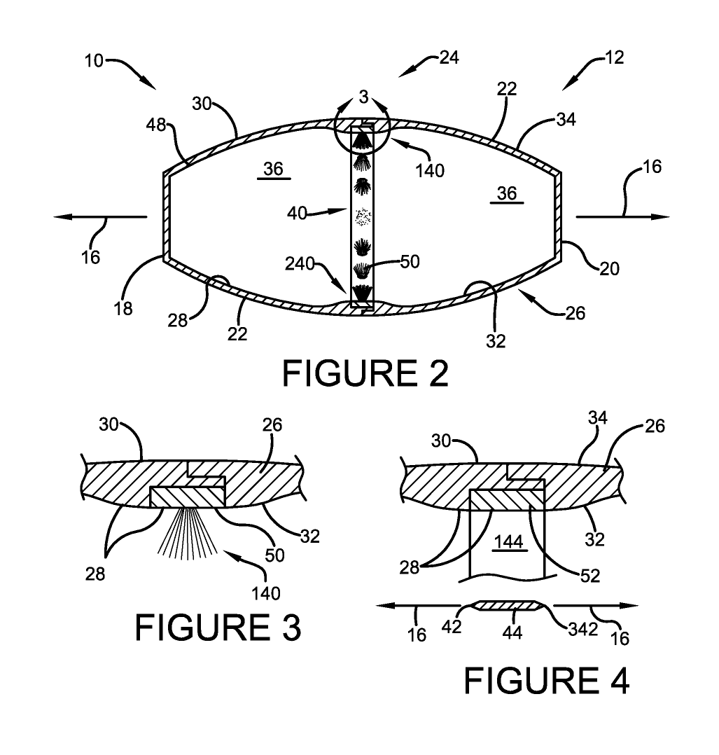

As show in FIGS. 1-3, a garlic processor 10 can include a container 12 and at least one of a bristle and a blade edge. The container 12 can extend along a central longitudinal axis 16 between a first end 18 and a second end 20 opposite the first end 18. The container 12 can have a side wall 22. The container 12 can include a first member 24 and a second member 26. The first member 24 can define a first inner surface 28 and a first outer surface 30. The second member 26 can define a second inner surface 32 and a second outer surface 34. The first member 24 and the second member 26 can be selectively engageable with one another. At least one of the first member 24 and the second member 26 can be configured to receive one or more cloves of garlic when the first member 24 and the second member 26 are disengaged with one another. The first inner surface 28 and the second inner surface 32 can cooperate to define a chamber 36 when the first member 24 and the second member 26 are engaged with one another.

A length of the container 12 can be defined along the axis 16 between the first end 18 and the second end 20. A lateral width of the container 12 can be defined in a plane transverse to the axis 16. The length of the container can be greater than the width. The outside shape of the garlic processor 10 can be formed in a way to facilitate easy grasping by a person or machine. The shape of the exemplary garlic processor 10 is football-like with truncated ends. The width of the garlic processor 10 can thus be variable along the axis 16 and the length can be greater than the maximum value of the width.

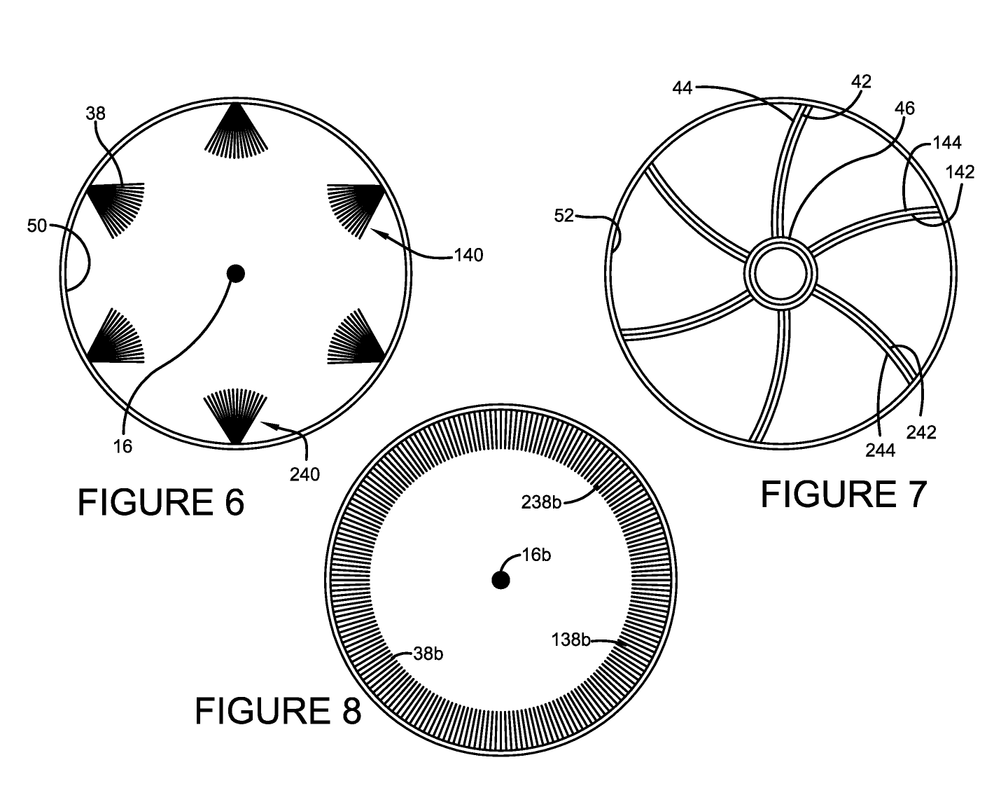

The at least one of the bristle and the blade edge can project away from the side wall 22 in the chamber 36 toward the axis 16 and be directed toward one of the first end 18 and the second end 20. FIG. 1 shows an embodiment of the present disclosure incorporating at least one bristle 38. The exemplary embodiment includes a plurality of bristles arranged in groupings 40, 140, 240. The groupings 40, 140, 240 can be evenly spaced from one another about the axis 16. This is best shown in FIG. 6. FIG. 8 shows an embodiment with bristles around the entire perimeter of a container, such as bristles 38b, 138b, 238b. Each bristle 38b, 138b, 238b can be a short, stiff, coarse, hair-like structure such as used in making brushes. Each bristle 38b, 138b, 238b can project toward an axis 16b from the side wall be directed toward one of the ends (such as ends 18, 20 of the first embodiment). Each bristle 38b, 138b, 238b can be directed toward one of the ends in that the sides of the bristles 38b, 138b, 238b confront one of the ends so that the garlic skin will engage the sides of the bristles 38b, 138b, 238b and be pulled away from the garlic clove.

The exemplary garlic processor 10 can also include at least one of the bristle and the blade edge in the form of a blade edge, such as blade edge 42. The exemplary garlic processor 10 can include a plurality of blade edges 42, 142, 242. The blade edges 42, 142, 242 can be defined by blades 44, 144, 244 extending from the side wall 22 to a ring member 46. The blade edges 42, 142, 242 can extend along respective arcuate paths to the ring member 46 in a plane containing the axis 16. This plane is best shown in FIG. 7. The blades edges 42, 142, 242 are directed toward one of the ends 18, 20. This is best shown in FIG. 4. In FIG. 4, the bristles 38 have been interchanged with blade edges in the container 12. The exemplary blade 44 is shown positioned in the chamber 36 generally at the axis 16. The cross-section of the blade 44 shown in FIG. 4 is not precisely at the axis 16, however shows the exemplary cross-section as it would appear along the axis 16. The blade 44 has edges 42 and 342. The edge 34 is directed toward the first end 18 and the edge 342 is directed to the second end 20. In a food processor, the blade edges are directed to laterally, perpendicular to the central longitudinal axis.

FIG. 10 is a third view taken in a plane perpendicular to a central longitudinal axis of a garlic processor according to other embodiments of the present disclosure. This plane is similar to the plane of FIG. 7. An exemplary garlic processor 10d can also include a support ring 52d. Straight blades 44d can extend across the otherwise open center of the support ring 52d. Embodiments of the present disclosure can include any desired number of blades. An embodiment with eight blades is illustrated in FIG. 10, but embodiments with two, three, four, ten or more blades could be practiced.

The at least one bristle and at least one blade can be interchangeable with respect to one another relative to the container 12. In the first exemplary embodiment, the groupings 40, 140, 240 can extend from a first support ring 50. The first support ring 50 can be viewed as a portion of the first member 24. The first member 24 can include a first sub-member 48 defining a first portion of the first inner surface 28 and defining the first end 18. The first member 24 can also include at least one second sub-member, such as in the form of the first support ring 50, defining a second portion of the first inner surface 28. The first sub-member 48 and the second sub-member can be selectively engageable with one another. The second sub-member and the second member 26 can be selectively engageable with one another. The blade edges 42, 142, 242 can extend from a second support ring 52. The second support ring 52 can replace in the first support ring 50 in the container 12 and define the second sub-member. The first support ring 50 can be viewed as an “alpha” second sub-member of the first member 24 and the second support ring 52 can be viewed as the “beta” second sub-member of the first member 24. The position of the first support ring 50 or second support ring 52 can be disposed at a position along the axis 16 of maximum width of the container 12.

The bristles 38 can thus be integral with the first support ring 50 and the blade edges 42 can be integral with the second support ring 52. Each of the first and second support rings 50, 52 can be selectively engageable with one of the first member 24 and the second member 26. In other words, for example, the first support ring 50 can be mounted on the first sub-member 48 during the separation of the garlic skin from the garlic clove, can be removed without damage and replaced with the second support ring 52 to dice the garlic, and re-attached the separate the skin from another piece of garlic.

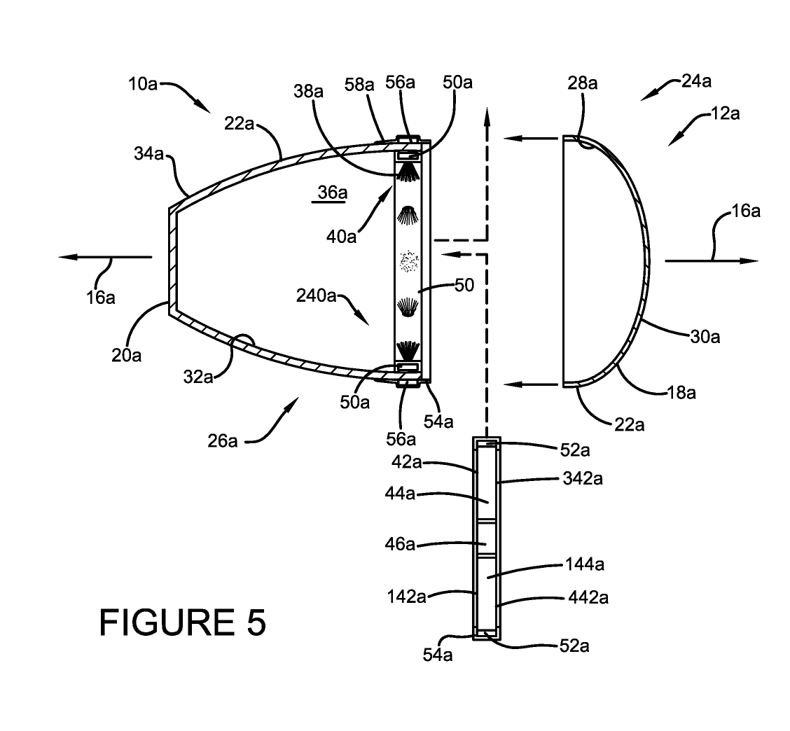

As show in FIG. 5, a garlic processor 10a can include a container 12a and at least one of a bristle and a blade edge. The container 12a can extend along a central longitudinal axis 16a between a first end 18a and a second end 20a opposite the first end 18a. The container 12a can have a side wall 22a. The container 12a can include a first member 24a and a second member 26a. The first member 24a can define a first inner surface 28a and a first outer surface 30a. The second member 26a can define a second inner surface 32a and a second outer surface 34a. The first member 24a and the second member 26a can be selectively engageable with one another. At least one of the first member 24a and the second member 26a can be configured to receive one or more cloves of garlic when the first member 24a and the second member 26a are disengaged with one another. The first inner surface 28a and the second inner surface 32a can cooperate to define a chamber 36a when the first member 24a and the second member 26a are engaged with one another.

The at least one of the bristle and the blade edge can project away from the side wall 22a in the chamber 36a toward the axis 16a and be directed toward one of the first end 18a and the second end 20a. FIG. 5 shows an embodiment of the present disclosure incorporating at least one bristle 38a. The exemplary embodiment includes a plurality of bristles arranged in groupings 40a, 140a. The groupings 40a, 140a can be evenly spaced from one another about the axis 16a. Each bristle 38a can be a short, stiff, coarse, hair-like structure such as used in making brushes. Each bristle 38a can project toward the axis 16a from the side wall be directed toward one of the ends 18a, 20a. Each bristle can be directed toward one of the ends 18a, 20a in that the side of the bristle 38a confronts one of the ends 18a, 20a so that the garlic skin will engage the side of the bristle 38a and be pulled away from the garlic clove.

The exemplary garlic processor 10a can also include at least one of the bristle and the blade edge in the form of a blade edge, such as blade edge 42a. The exemplary garlic processor 10 can include a plurality of blade edges 42a, 142a, 342a, 442a. The blade edges 42a, 142a, 342a, 442a can be defined by blades 44a, 144a extending from the side wall 22 to a ring member 46a. The blade edges 42a, 142a, 342a, 442a can extend along respective arcuate paths to the ring member 46a in a plane containing the axis 16. The blades edges 42a, 142a, 342a, 442a are directed toward one of the ends 18a, 20a. The bristles 38a can be interchanged with the blade edges 42a, 142a, 342a, 442a in the container 12.

The embodiment of the present disclosure shown in FIG. 5 can include at least one magnet releasably interconnecting the at least one of the bristle and the blade edge with the one of the first member 24 and the second member 26. The groupings 40a, 140a, 240a can extend from a first support ring 50a. The blade edges 42a, 142a, 342a, 442a can extend from a second support ring 52a. The second support ring 52a can replace in the first support ring 50a in the container 12a as desired. The support rings 50a, 52a can be steel and encased in silicone (referenced at 54a). An annular magnet 56a can be positioned on the outside of the container 12a and can be bonded to the container 12a, such as with a layer of elastomer 58a. When one of the support rings 50a, 52 is placed in the second member 26a, the magnet 56a can attract the ring and hold the ring in place. The first member 24a can be formed from steel or partially from steel so that the magnet 56a can also hold the first member 24a in place.

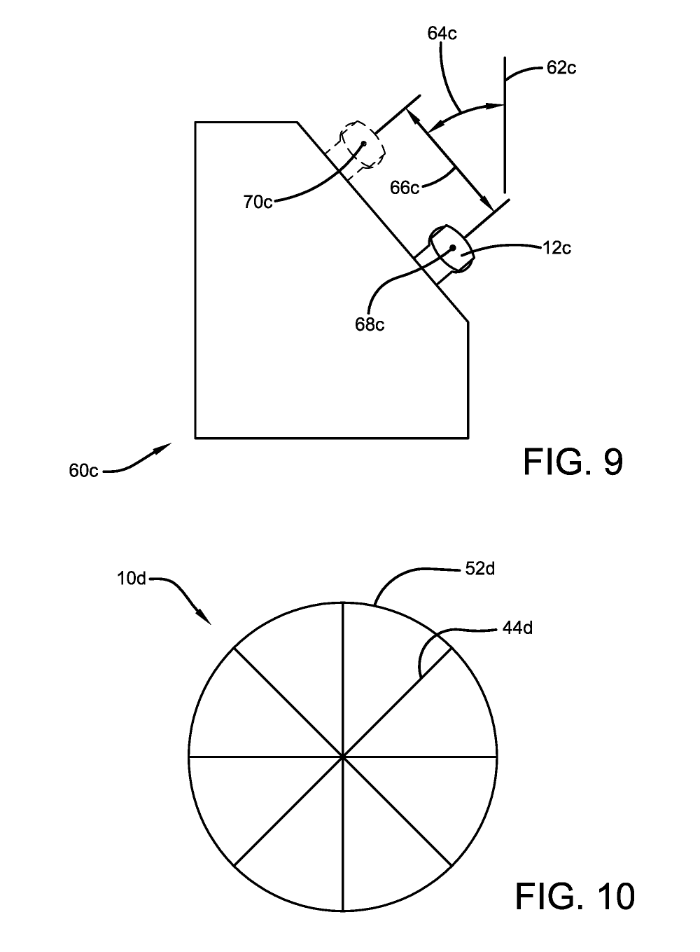

FIG. 9 is a side view of an exemplary shaking machine 60c for shaking one or more embodiments of the present disclosure. In FIG. 9, the shaking machine 60c can shake a container 12c. The shaking machine 60c can be configured to shake the container 12c at an angle of between fifty and eighty degrees to vertical. In FIG. 9, the vertical axis is referenced at 62c and the angle is referenced at 64c. The shaking machine 60c can be configured to shake the container 12c over a travel distance of between eight and twelve inches. In FIG. 9, the travel distance is referenced at 66c. The shaking machine 60c can be configured to shake the container 12c at an oscillating frequency of between two cycles per second. The shaking machine can move the container 12c from the point referenced at 68c, to the point 70c, and back to the point 68c in one half of one second. The shaking machine 60c can be configured to shake the container 12c for a duration of between twenty to sixty seconds.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved. In apparatus claims

What is claimed is:

1. A garlic processor comprising:
a container extending along a central longitudinal axis between a first end and a second end opposite the first end and having a side wall, said container including a first member defining a first inner surface and a first outer surface and a second member defining a second inner surface and a second outer surface, said first member and said second member selectively engageable with one another, at least one of said first member and said second member configured to receive one or more cloves of garlic when said first member and said second member are disengaged with one another, said first inner surface and said second inner surface cooperating to define a chamber when said first member and said second member are engaged with one another; and
at least one of a bristle and a blade edge projecting away from said side wall in said chamber toward said axis and directed toward one of said first end and said second end.

2. The garlic processor of claim 1 wherein a length of said container is defined along said axis between said first end and said second end and a lateral width of said container is defined in a plane transverse to said axis and wherein said length is greater than said width.

3. The garlic processor of claim 2 wherein said width is variable along said axis and said length is greater than a maximum value of said width.

4. The garlic processor of claim 1 wherein said at least one of said bristle and said blade edge is integral with one of said first and said second member.

5. The garlic processor of claim 1 wherein said first member further comprises:
a first sub-member defining a first portion of said first inner surface and defining said first end;
at least one second sub-member defining a second portion of said first inner surface, said first sub-member and said second sub-member selectively engageable with one another, said second sub-member and said second member selectively engageable with one another; and
wherein said at least one of said bristle and said blade edge is integral with said second sub-member.

6. The garlic processor of claim 5 wherein:
said at least one second sub-member is further defined as an alpha second sub-member and a beta second sub-member, at least one of said alpha second sub-member and said beta second sub-member selectively engageable with said first sub-member at a time; and
said at least one of said bristle and said blade edge is further defined as at least one bristle integral with said alpha second sub-member and at least one blade edge integral with said beta second sub-member.

7. The garlic processor of claim 1 wherein said at least one of said bristle and said blade edge is selectively engageable with one of said first member and said second member.

8. The garlic processor of claim 7 wherein said at least one of said bristle and said blade edge further comprises:
at least one bristle; and
at least one blade edge, wherein each of said at least one bristle and said at least one blade edge is selectively engageable with said one of said first member and said second member at a time.

9. The garlic processor of claim 7 further comprising:
at least one magnet releasably interconnecting said at least one of said bristle and said blade edge with said one of said first member and said second member.

10. The garlic processor of claim 1 wherein said at least one of said bristle and said blade edge further comprises a plurality of bristles.

11. The garlic processor of claim 10 wherein said plurality of bristles further comprises at least one grouping of bristles extending from a common position along said side wall.

12. The garlic processor of claim 11 wherein said at least one grouping of bristles further comprises a plurality of groupings of bristles evenly spaced from one another about said axis.

13. The garlic processor of claim 1 wherein said at least one of said bristle and said blade edge further comprises a plurality of blade edges.

14. The garlic processor of claim 13 wherein said at least one of said bristle and said blade edge further comprises:
a ring member, wherein each of said plurality of blade edges extend from said side wall to said ring member.

15. The garlic processor of claim 14 wherein said at least some of said plurality of blade edges extend along arcuate paths in a plane containing said axis.

16. A garlic processor comprising:
a container extending along a central longitudinal axis between a first end and a second end opposite the first end and having a side wall, said container including a first member defining a first inner surface and a first outer surface and a second member defining a second inner surface and a second outer surface, said first member and said second member selectively engageable with one another, at least one of said first member and said second member configured to receive one or more cloves of garlic when said first member and said second member are disengaged with one another, said first inner surface and said second inner surface cooperating to define a chamber when said first member and said second member are engaged with one another; and
at least one of a bristle and a blade edge projecting away from said side wall in said chamber toward said axis and directed toward one of said first end and said second end, said at least one of said bristle and said blade edge including at least one bristle and at least one blade interchangeable with respect to one another relative to said container.

17. The garlic processor of claim 16 wherein said at least one of said bristle and said blade edge further comprises:
a first support ring wherein said at least one bristle is integral with said first support ring and said first support ring is selectively engageable with one of said first member and said second member; and
a second support ring wherein said at least one blade edge is integral with said second support ring and said second support ring is selectively engageable with said one of said first member and said second member.

18. The garlic processor of claim 17 wherein said at least one bristle further comprises a plurality of groupings of bristles, each of said plurality of groupings extending from respective common positions along said first support ring and evenly spaced from one another about said axis.

19. The garlic processor of claim 18 wherein said at least one blade edge further comprises a plurality of blade edges extending along respective arcuate paths in a plane containing said axis.

20. The garlic processor of claim 19 further comprising:
a shaking machine configured to shake said container at an angle of between fifty and eighty degrees, a travel distance of between eight and twelve inches, at an oscillating frequency of between two cycles per second, for a duration of between twenty to sixty seconds.
